(19) United States
(12) Patent Application Publication
(10) Pub. No.: US 2013/0282569 A1
(43) Pub. Date: Oct. 24, 2013

(54) METHOD, TERMINAL AND SYSTEM FOR PROVIDING DATA TRANSMISSION AND FINANCIAL TRANSACTION BASED ON THE POSITION OF MOBILE TERMINALS HAVING SHORT-RANGE COMMUNICATION FUNCTION

(71) Applicant: KT CORPORATION, Seongnam-si (KR)

(72) Inventor: Moon-Soon KANG, Seongnam-si (KR)

(21) Appl. No.: 13/927,550

(22) Filed: Jun. 26, 2013

Related U.S. Application Data
(62) Division of application No. 13/441,579, filed on Apr. 6, 2012.

(30) Foreign Application Priority Data
Apr. 6, 2011 (KR) 10-2011-031791

(51) Int. Cl. G06Q 20/32

(52) U.S. Cl. CPC G06Q 20/325
USPC 705/39

(57) ABSTRACT

Method and terminal for performing a financial transaction based on a relative position between terminals. A system for performing a financial transaction based on a relative position of mobile terminals includes: a user terminal configured to generate payment data in association with a transaction amount and to deduct the transaction amount from a payer account; a transaction terminal configured to receive the payment data from the user terminal by use of short-range communication and to add the transaction amount corresponding to the payment data to a payee account; and a financial server configured to approve the financial transaction based on the payment data, wherein the payment data is determined by a positional relationship between the user terminal and the transaction terminal.

### CROSS-REFERENCE TO RELATED APPLICATION

This application is a divisional of U.S. patent application Ser. No. 13/441,579, filed Apr. 6, 2012, which claims priority from Korean Patent Application No. 10-2011-0031791, filed on Apr. 6, 2011. The disclosures of the prior applications are hereby incorporated in their entireties by reference.

### BACKGROUND

1. Field

Methods, terminals and systems consistent with exemplary embodiments relate to a method, terminal, and system for performing a financial transaction based on a relative position between terminals having a short-range communication function.

2. Description of the Related Art

Conventionally, the financial transaction on a user terminal only involves checking a bank account or transferring to another account. For these operations, it is usually required that a user signs into the bank account by aid of an application provided by the bank and then the user performs the financial transaction.

An electronic wallet is one of the payment services available on a user terminal. With the electronic wallet, the user can pay online or offline by using a pre-registered payment option on the user terminal. In the transaction using the conventional electronic wallet, it is conventionally possible to perform a one-way transaction only from the user to a seller. Thus, the conventional way of transferring money had to be used in order to make a financial transaction between users.

In addition, since the user terminal has a small screen and can not display as much information as a personal computer, it has been cumbersome and counter-intuitive to perform the financial transaction, which involves going through several operations of authentication and transaction procedures, on the user terminal.

Therefore, there is a need to develop a technology for easily and intuitively performing a financial transaction on the user terminal without the shortcomings mentioned above.

### SUMMARY

In one exemplary embodiment, there is provided a system for performing a financial transaction based on a relative position of mobile terminals. The system includes a user terminal configured to generate payment data in association with a transaction amount and to deduct the transaction amount from a payer account, a transaction terminal configured to receive the payment data from the user terminal via a communication link and to add the transaction amount corresponding to the payment data to a payee account, and a financial server configured to approve the financial transaction based on the payment data, wherein the payment data is determined by a positional relationship between the user terminal and the transaction terminal. The communication link may be a short-range communication link.

The payment data may be generated when the user terminal is placed above the transaction terminal while the communication link is established between the user terminal and the transaction terminal.

The financial server checks whether balance data of the payer account and balance data of the payee account are valid based on the payment data to approve the financial transaction between the user terminal and the transaction terminal.

In another exemplary embodiment, there is provided a user terminal for performing a financial transaction based on a relative position with a transaction terminal. The user terminal includes a sensor which obtains first position data of the user terminal, a communication module configured to establish a communication link with the transaction terminal and to communicate with the transaction terminal via the communication link, a controller which generates payment data for a transaction amount based on the first position data of the user terminal and second position data of the transaction terminal received via the communication link, and a communication tag configured to store the payment data, wherein the payment data is transmitted to the transaction terminal via the communication link. The communication module may be a short-range communication module, and the communication tag may be a short-range communication tag.

The controller determines a positional relationship between the two terminals based on the first position data of the user terminal and the second position data of the transaction terminal to generate the payment data if the user terminal is placed above the transaction terminal.

The sensor may be one of a gyro sensor configured to determine whether a front face of the user terminal is facing away from the ground and a luminance sensor configured to determine whether the user terminal is placed above the transaction terminal.

The user terminal may further have a mobile communication module configured to communicate with a financial server, the financial server configured to approve the financial transaction.

The user terminal may further have an input device configured to recognize touch input for transmitting the payment data to the transaction terminal.

In still another exemplary embodiment, there is provided a method of performing a financial transaction based on a relative position of mobile terminals. The method includes generating payment data in association with a transaction amount based on positional relationship between a user terminal and a transaction terminal, deducting the transaction amount from a payer account of the user terminal, transmitting the payment data to the transaction terminal in order to add the transaction amount to a payee account of the transaction terminal, and requesting an approval of the financial transaction from a financial server. The requesting of the approval may be carried out by the user terminal.

The user terminal may further establish a communication link with the transaction terminal. The establishing of the communication link may be performed by the user terminal.

The requesting an approval of the financial transaction may include transmitting balance data of the payer account and balance data of the payee account to the financial server, checking whether the balance data of the payer account and the balance data of the payee account are valid and approving the financial transaction, the checking and approving being carried out by the financial server, and receiving an approval result from the financial server. The user terminal may receive the approval result.

The positional relationship can be a vertical positional relation of the two terminals that is sensed by the sensor equipped in at least one from among the user terminal and the transaction terminal.

The transmitting the payment data may be transmitting the payment data from the user terminal to the transaction terminal in response to touch input of a user.

The transaction amount that is recharged by a communication between the user terminal and a recharging device may be recorded on the payer account, the recharging device may transmit a balance data of the payer account to the financial server after recharging is finished, and the financial server may store the balance data of the payer account.

The user terminal may communicate with the recharging device via a short-range communication link.

In yet another exemplary embodiment, there is provided a transaction terminal for performing a financial transaction based on a relative position with a user terminal. The transaction terminal includes: a sensor which obtains first position data of the user terminal; a communication module configured to establish a communication link with the user terminal and to communicate with the user terminal via the communication link; a controller which receives generated payment data from the user terminal via the communication link and adds a transaction amount corresponding to the payment data to a payee account.

The generation of payment data may be based on at least a positional relationship between the user terminal and the transaction terminal. The payment data may be generated based on the user terminal being placed above the transaction terminal.

### BRIEF DESCRIPTION OF THE ACCOMPANYING DRAWINGS

FIG. 1 is an overall view briefly illustrating a financial transaction system according to one exemplary embodiment.

FIG. 2 is a block diagram of a user terminal according to one exemplary embodiment.

FIG. 3 is a flow diagram showing a positional relationship of two terminals for a financial transaction in accordance with one exemplary embodiment.

FIG. 4 is a flow diagram showing how a certain amount of money is recharged in the user terminal according to one embodiment.

FIGS. 5a and 5b are flow diagrams illustrating how a certain amount of money is transmitted from the user terminal to a transaction terminal according to one exemplary embodiment.

FIG. 6 is a flow diagram illustrating how transmission of a transaction amount is canceled from the user terminal to the transaction terminal according to one exemplary embodiment.

FIGS. 7a and 7b are flow diagrams illustrating how a certain amount of money is transmitted from the user terminal to a transaction terminal according to another exemplary embodiment.

FIG. 8 is a flow diagram illustrating how a certain amount of money is transmitted from the user terminal to a transaction terminal according to yet another exemplary embodiment.

### DETAILED DESCRIPTION

Since there can be a variety of permutations and exemplary embodiments, certain exemplary embodiments will be illustrated and described with reference to the accompanying drawings. This, however, is by no means to restrict the present invention to certain embodiments, and the present invention shall be construed as including all permutations, equivalents and substitutes covered by the ideas and scope of the specification and drawings.

Throughout the description, terms such as “first” and “second” can be used in describing various elements to distinguish one element from the other.

Also, in this specification, when mentioning that one element is “connected” or “coupled” to another element, it is possible for one element to be directly connected or coupled to another element, but if there is no description to the contrary, it should be appreciated that it is also possible to be connected or coupled via medium or another element.

Hereinafter, the user terminal according to an exemplary embodiment will be described in detail with reference to the accompanying drawings.

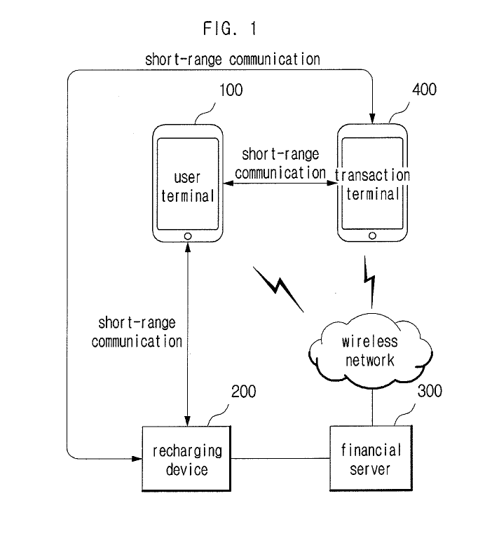

FIG. 1 is an overall view briefly illustrating a financial transaction system according to one exemplary embodiment.

As shown in FIG. 1, the financial transaction system comprises a user terminal 100 having a short-range communication function and a financial server 300. In addition, the financial transaction system can further comprise a recharging device 200 for recharging a certain amount of money in the user terminal 100.

The short-range communication used in the financial transaction system can include Near Field Communication (NFC), or other similarly-functioning Bluetooth, Radio Frequency Identification (RFID), infrared communication, and Zigbee technologies. In this specification, exemplary embodiments using NFC will be described.

NFC is a type of short-range wireless communication technology. NFC can perform a bi-directional communication between devices within 10-20 cm. NFC is an extension of the ISO/IEC 14443 proximity-card standard (contactless card or RFID) and can support a smart card and a reader simultaneously. Also, since NFC is the extension of the ISO/IEEE 14443 standard, it can communicate with the reader or smart card complying with the ISO/IEEE 14443 standard as well as between NFC devices. NFC was initially developed for use in a user terminal.

Presently, NFC is mainly used on a user terminal, and can operate in three modes of card emulation, reader/writer emulation, and inter-device communication (peer-to-peer communication). In the card emulation mode, NFC operates in the same way as the conventional RFID card. Accordingly, the user can approach the user terminal instead of applying the conventional card to the RFID reader. The current specifications of the contactless smart card have a frequency of 13.56 MHZ, a range of 10 cm or less and a communication speed of 106 kbps or more, and its applications include payment or toll collection. In the reader/writer emulation mode, the NFC device can operate as a card reader. The NFC device can read data from another NFC device or smart card.

In the inter-device communication mode, two NFC devices can communicate bi-directionally with each other (peer-to-peer; P2P). In the inter-device communication mode, the NFC devices can communicate data at the maximum of 424 kbps. The user can approach the user terminal to a printer to transmit a picture data, or to a display device to display a picture. It is possible to transmit data regardless the type of data (i.e., text, video, sound, etc.). In the inter-device communication mode, which is different from server/client communication, the NFC devices located within 10 cm from each other can communicate data at the maximum of 424 kbps in the P2P method.

The financial transaction system enables the user terminal 100 to transmit financial data to another terminal or to receive the financial data from another terminal. The financial data can be account data, a transferring amount, an electronic gift certificate or an electronic coupon. NFC is used as a means for performing financial transaction between the terminals. The user terminal 100 or the transaction terminal 400 can deposit or recharge a certain amount into an account associated with each terminal in advance. In this exemplary embodiment, the financial server 300 can manage the recharged amount and balance data of the account, and the balance data can be configured to be synchronized in real time or whenever the financial transaction occurs. In addition, the user terminal 100 or the transaction terminal 400 can purchase the electronic gift certificate or the electronic coupon in advance. In one exemplary embodiment, the financial transaction between the user terminal 100 and the transaction terminal 400 will be described. Moreover, although an example of transferring a certain amount from the user terminal 100 to the transaction terminal 400 is described here, it shall be appreciated that transfer from the transaction terminal to the user terminal also falls into the scope of an exemplary embodiment.

The user terminal 100 can perform short-range communication with the transaction terminal 400 and the recharging device 200 by a short-range module and a short-range communication tag. In addition, the user terminal 100 and the transaction terminal 400 can establish a communication link in the P2P method to communicate with each other.

The user terminal 100 can transfer a certain amount of money within the balance of an account associated with the user terminal 100 to an account associated with the transaction terminal 400. Hereinafter, the account associated with the user terminal 100 will be referred as a “payer account” and the account associated with the transaction terminal 400 will be referred as a “payee account.”

The user can recharge a certain amount of money in the payer account in advance. The payer account can be recharged through communication between the user terminal 100 and the recharging device 200.

In order to perform the financial transaction between the user terminal 100 and the transaction terminal 400, a separate financial transaction application may be needed. In addition, the financial transaction application can communicate data such as financial transaction data or the balance data with the financial server 300 via a wireless Internet or a mobile network.

Once the user terminal 100 approaches the transaction terminal 400 to establish a communication link, the user terminal 100 can read the short-range communication tag of the transaction terminal 400 by using the short-range communication module. Here, a positional relationship with the transaction terminal 400 can be determined by using position data obtained by a sensor and position data received from the transaction terminal 100.

For example, as shown in FIG. 3, when the user terminal 100 is placed above the transaction terminal 400, the user terminal 100 can transmit a certain amount of money to the transaction terminal 400. On the other hand, when the user terminal 100 is placed beneath the transaction terminal 400, a certain amount of money can be transmitted from the transaction terminal 400 to the user terminal 100.

Here, it can be determined whether the user terminal 100 is placed above or beneath the transaction terminal 400 by using at least one from among a gyro sensor, a gravity sensor and a luminance sensor. For example, in FIG. 3, the user terminal 100 can use the luminance sensor in the sensors 170 to determine whether the transaction terminal 400 is not placed above a front face of the user terminal 100, and the gyro sensor in the sensors 170 to determine whether the front face (i.e., a display 155) of the user terminal 100 is facing upward (i.e., in the opposite direction to the ground). Therefore, it is possible to assess the current positional relationship between the two terminals by using at least one sensor.

In addition, the user terminal 100 may perform the short-range communication with the transaction terminal 400 only when the user terminal 100 is located within a certain distance from the transaction terminal 400. This distance will be referred as a communicable distance d, and in the case of NFC, it is possible to establish an NFC communication link generally within 10-20 cm. However, this communicable distance d can be affected by the kind of short-range communication and the surrounding environment.

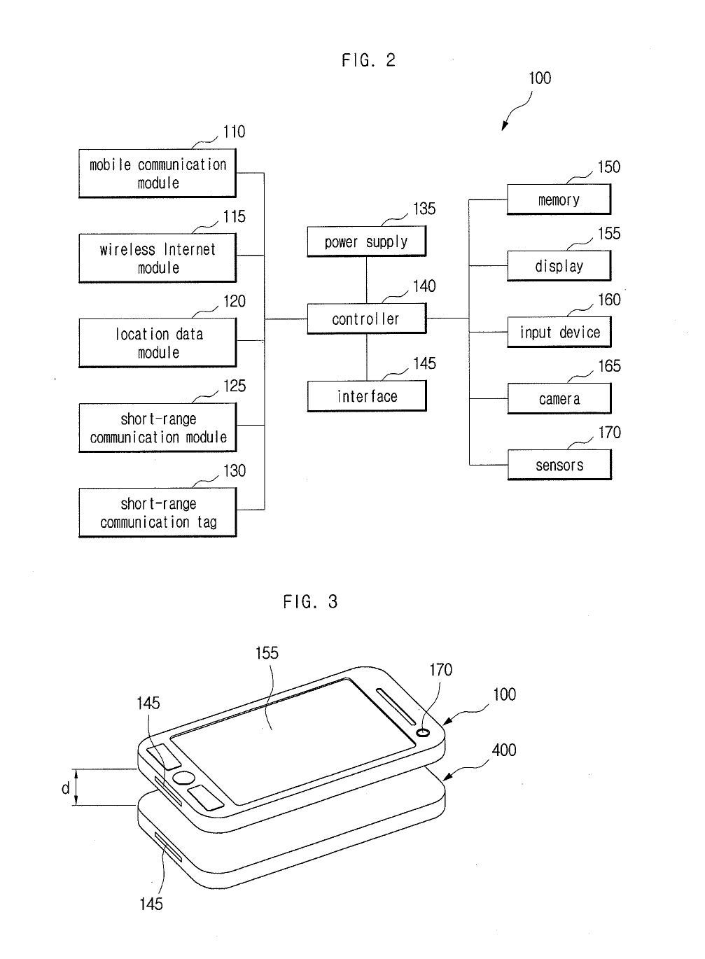

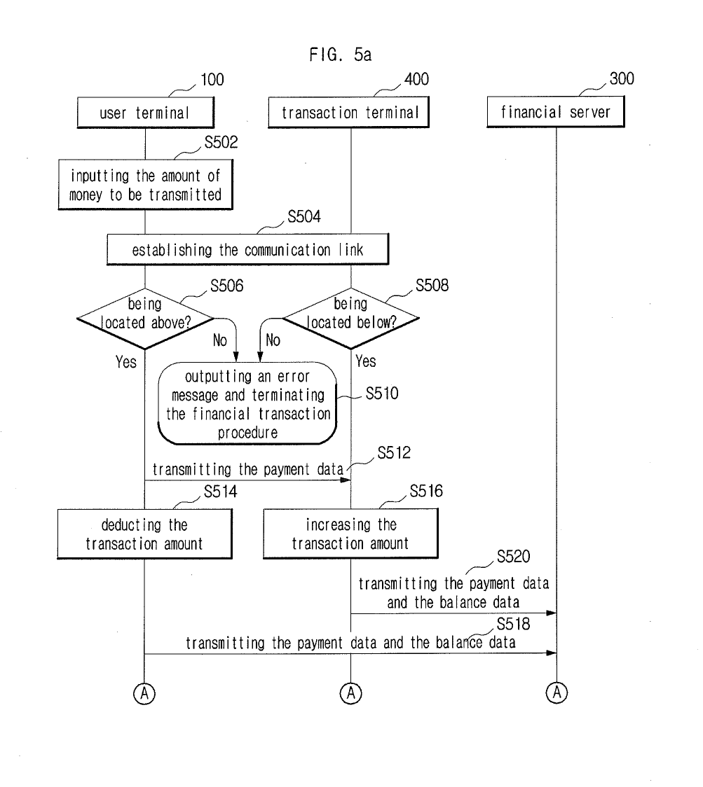

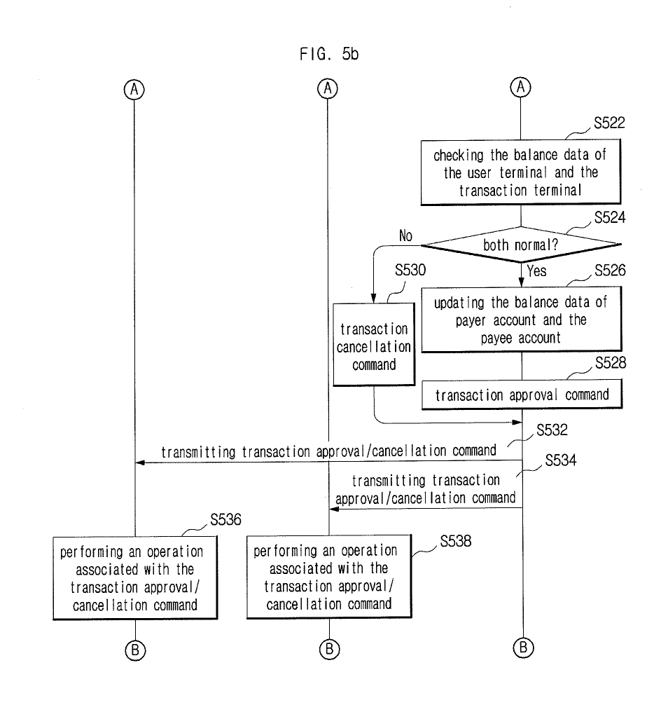

The detailed configuration of the user terminal 100 will be described later in FIG. 2. Also, the method of processing the financial transaction between the user terminal 100 and the transaction terminal 400 will be described below with reference to FIGS. 5a/5b-7a/b.

The user terminal 100 can recharge a certain amount of money in the payer account in advance by using the recharging device 200.

The recharging device 200 can be provided with the NFC function or any equivalent short-range communication function, and can recharge a certain amount of money or transmit the electronic gift certificate to the user terminal 100 or the transaction terminal 400.

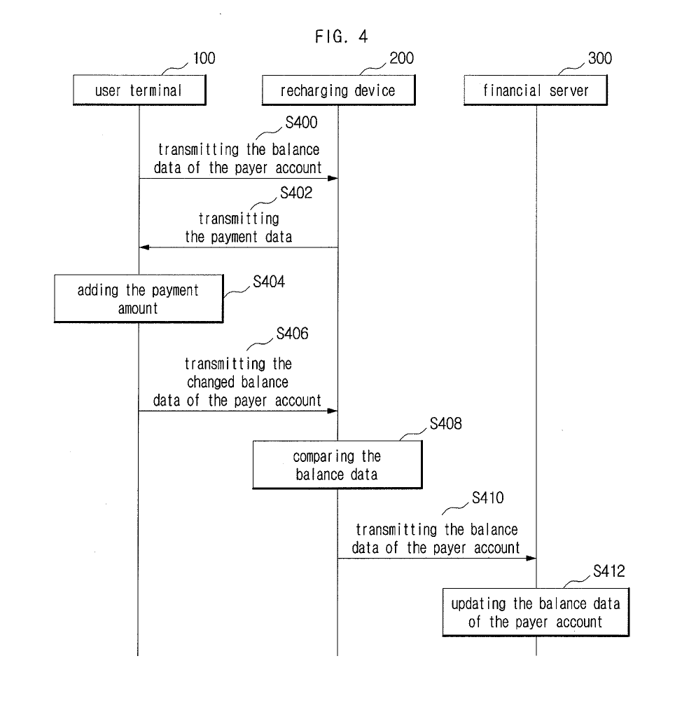

The recharging device 200 can establish a communication link with the user terminal 100 by using NFC. The recharging device 200 can communicate with the financial server 300 via a network, and provide recharging data associated with the user terminal 100 and the balance data of the payer account to the financial server 300. The procedure of recharging a certain amount of money in the user terminal 100 by using the recharging device 200 will be described in detail in FIG. 4. There can be various methods of recharging in the payer account associated with the user terminal 100, for example, transferring fund via the Internet as well as using the recharging device 200.

The financial server 300 is for providing the financial transaction service according to one exemplary embodiment, and determines whether the recharging procedure between the user terminal 100 and the recharging device 200 or the financial transaction between the user terminal 100 and the transaction terminal 400 is terminated normally. Also, the financial server 300 checks for the validity of the accounts data associated with the terminals.

The financial server 300 can manage the account data associated with the terminals, and can make sure that the account data stored in the terminals are synchronized. Also, if the financial transaction between terminals is not normal or the balance data of the account after the financial transaction is not valid, the financial sever 300 can cancel and restore the transaction to the account data that existed before the financial transaction.

In addition, if there is a change in the balance data of the payer account, the user terminal 100 can provide the changed balance data to the financial server 300 by performing direct/indirect communication with the financial server 300.

Hereinafter, the detailed configuration of the user terminal 100 having the NFC function will be described.

FIG. 2 is a block diagram of the user terminal according to one embodiment.

As shown in FIG. 2, the user terminal 100 can comprise a mobile communication module 110, a wireless Internet module 115, a location data module 120, a short-range communication module 125, a short-range communication tag 130, a power supply 135, a controller 140, an interface 145, a memory 150, a display 155, an input device 160, a camera 165, and sensors 170.

The mobile communication module 110 performs mobile communication between the user terminal 100 and a mobile communication system. More particularly, the mobile communication module 110 communicates a wireless signal with at least one from among a Base Station Controller (BSC) or Radio Network Controller (RNC), an external terminal and a server via a mobile communication network. The wireless signal can be one of a voice call signal, a video call signal and various types of data calls such as text or multimedia message.

The mobile communication module 110 can communicate with the financial server 300 in order to get a financial transaction with the user terminal 100 approved. Also, the communication with the financial server 300 can be performed via the wireless Internet module 115 instead of, or in addition to, via the mobile communication module 110.

The wireless Internet module 115 is for accessing Internet wirelessly. The wireless Internet module 115 can be embedded within or externally coupled to the user terminal 100. It is possible to use a conventional communication technology such as WLAN (Wireless LAN, Wi-Fi), Wibro (Wireless broadband), Wimax (World Interoperability for Microwave Access), and HSDPA (High Speed Downlink Packet Access) as means for using the wireless Internet.

The location data module 120 is for determining or obtaining a location of the user terminal 100. The GPS (Global Position System) can be an example of the location data module 120. The location data module 120 processes distance data from at least three satellites to one point and time data at which the distance data is measured and applies trigonometry to the processed data to calculate three-dimensional location data according to latitude, longitude and altitude for the one point at one time.

In addition, the location data module 120 can calculate the location and time data by aid of three satellites and compensate errors in the calculated location and time data by aid of another satellite. Also, the location data module 120 can also calculate the current location in real time to calculate the speed data.

The short-range communication module 125 is configured for short-range communication. NFC is a representative example of short-range communication, and Bluetooth, radio frequency identification (RFID), infrared communication (IrDA, infrared Data Association), Ultra Wideband (UWB) and ZigBee can be also used. One exemplary embodiment can be implemented with the NFC technology.

The short-range communication module 125 can establish a communication link with a short-range communication module provided in the transaction terminal 400 or the recharging device 200. Here, the distance by which the communication link is established can be, in the case of NFC, within about 10-20 cm.

The short-range communication module 125 can read data from the short-range communication tag in the transaction terminal 400 via the established link. The short-range communication tag 130 can store terminal identification data of the user terminal 100, payment data, and the payer account data.

The short-range communication tag 130 can comprise an antenna and an integrated circuit, and can store data in the integrated circuit and transmit data to a short-range communication reader via the antenna. The short-range communication tag and the short-range communication reader can communicate data with each other by aid of an electromagnetic wave.

The power supply 135 can be powered from an external power source or an internal power source under the control of the controller 140, and can provide the power required for operation of each component.

The controller 140 generally controls overall operation of the mobile terminal. For example, the controller 140 controls or processes a voice call, data call or video call. Also, the controller 140 can be provided with a multimedia module for playing back multimedia data.

In addition, the controller 140 can perform calculation by using the position data of the user terminal 100 that is provided by the sensors 170, and can determine a relative positional relationship between the user terminal 100 and the transaction terminal 400 based on the calculation.

Specifically, the controller 140 can determine the current position of the user terminal 100 by receiving the position data of the user terminal 100 that the sensors 170 provides. Also, the controller 140 can compare the position data of the transaction terminal 400 that is received via the communication link established by aid of the short-range communication module 125, with the position data of the user terminal 100 and determine the relative positional relationship between the two terminals.

For example, as shown in FIG. 3, the financial transaction system can require a condition in which the communication link be established through NFC communication while two terminals are vertically overlapped in order for a financial transaction to be made between the two terminals. In this case, it can be configured in such a way that a predetermined amount of money is transmitted from the terminal placed above to the terminal placed below.

In order to determine whether the above condition is met for the financial transaction, the controller 140 can use the position data of the user terminal 100 and the received position data of the transaction terminal 400. For example, in order to determine whether the front face (i.e., a side where the display 155 is located) of the user terminal 100 is facing in the opposite direction of the ground (i.e., in an upward direction), the controller 140 can use the position data that is sensed by the gyro sensor or the gravity sensor. In addition, in order to determine whether the user terminal 100 is overlapped above a top side of the transaction terminal 400, the controller can use luminance data sensed by the luminance sensor.

By using these data, the controller 140 can determine the positional relationship between the two terminals. Only when the user terminal 100 is placed above the transaction terminal 400, the controller 140 can determine that it is possible to make the financial transaction from the user terminal 100 to the transaction terminal 400.

The controller 140 can issue payment data for the transaction amount by using the position data of the user terminal 100 and the position data of the transaction terminal 400, and can allow the issued payment data to be transmitted to the transaction terminal via the communication link.

The interface 145 is for connecting the user terminal 100 to any external devices. The interface 145 receives data or power from the external device and delivers the data or power to each component in the user terminal 100, or transmits data from the user terminal 100 to the external device. For example, the interface 145 can include at least one from among a cord/cordless headset port, an external recharger port, a cord/cordless data port, a memory card port, a port for connecting a device having an identification module, an audio I/O (input/output) port, a video I/O port, an earphone port and the like.

The memory 150 can store a program for operation of the controller 140 and input/output data (i.e., phonebook messages, still images, video, etc.). In addition, the memory 150 can store data for various patterns of vibrations and sounds that are outputted when there is a touch input on a touch screen.

The memory 150 can also be in the form of storage medium, such as a flash memory, a multimedia card micro type memory, a card type memory (i.e., an SD or XD memory), a hard disk drive, Random Access Memory (RAM), Static Random Access Memory (SRAM), Read-Only Memory (ROM), Electrically Erasable Programmable Read-Only Memory (EEPROM), Programmable Read-Only Memory (PROM), a magnetic memory, a magnetic disk and an optical disk.

The display 155 is for displaying information that is processed in the user terminal 100. For example, when the user terminal is in a voice call mode, a User Interface (UI) or Graphic User Interface (GUI) associated with the call mode is displayed. When the user terminal is in a video call mode or a camera mode, a recorded video and/or received video, or UI or GUI can be displayed.

The display 155 can be realized with a flat panel display, such as an Liquid Crystal Display (LCD), a Thin Film Transistor-Liquid Crystal Display (TFT-LCD), an Organic Light-Emitting Diode (OLED) and a flexible display, or a 3D display. In addition, based on how it is implemented, the user terminal 100 can have more than one display 155. For example, at least two displays 155 can be arranged to be separated or integrated on a same face of the user terminal 100, or can be arranged respectively on different faces.

The input device 160 is a user interface for receiving various commands from the user, and there is no restriction on how the input device is implemented. For example, the input device 160 can be implemented with more than one component, such as a key pad, a touch pad (pressure/capacitive type), a wheel key and a jog switch.

Also, since it is common for today's user terminals 100 to adopt a touch screen, the input device 160 in this exemplary embodiment can be integrated with the display 155 to implement soft keys on an entire screen of the display.

In addition, the input device 160 can recognize touch input of the user for transmitting the payment data from the user terminal 100 to the transaction terminal 400 during the financial transaction. The input device 160 can send the recognized touch input to the controller 140 so that the controller 140 can recognize whether the touch input is inputted.

The camera 165 processes image frames of a still image or a moving image obtained by an image sensor in the video call mode or camera mode. The processed image frames can be presented on the display 155.

The image frames processed by the camera 165 can be either stored in the memory 150 or transmitted externally via any one of the mobile communication module 110, the wireless Internet module 115 and the short-range communication module 125. Also, there can be more than one camera 165, depending on the configuration of the user terminal 100.

The sensors 170 sense a current status of the user terminal 100, such as an open/close state of the user terminal 100, the location of the user terminal 100, touch input from the user, an orientation of the user terminal, and acceleration/deceleration of the user terminal, to generate a sensing signal for controlling the operation of the user terminal 100. For example, in case that the user terminal is a sliding-type phone, the open/close state of the phone can be sensed. In addition, the sensors 170 can perform various sensing functions such as sensing the power provided by the power supply 135 and sensing the connection with an external device via the interface 145.

The sensors 170 detect the shaking of the user terminal 100 and notify what is detected to the controller 140. In addition, the sensors 170 can measure whether the user terminal 100 is flipped, by what angle the user terminal 100 is tilted angle and by which direction the user terminal 100 is oriented, and can provide the controller 140 with the measured position data. For example, if the user terminal 100 is provided with the gyro sensor, it is possible to measure the position data of the user terminal 100 by aid of the gyro sensor to determine the current position of the user terminal 100. In addition, it is also possible to measure the position data of the user terminal 100 by at least one from among an acceleration sensor, the gravity sensor, and a compass sensor, instead of the gyro sensor.

In addition, the sensors 170 can determine whether another terminal is laid above the user terminal 100. For example, the sensors 170 can determine whether there is any obstacle before the front face of the user terminal 100 by aid of the luminance sensor and provide to the controller 140 the position data as basic information that shows whether the user terminal is above or beneath the transaction terminal 400.

Hereinafter, the procedure of recharging a certain amount of money in the user terminal 100 by use of the recharging device 200 will be described.

FIG. 4 is a flow diagram illustrating how a certain amount of money is recharged in the user terminal according to one embodiment.

As shown in FIG. 4, the user terminal 100 communicates with the recharging device 200 by use of NFC communication, and the recharging device 200 communicates with the financial server 300 via a wired/wireless network.

When the user pays money to be recharged, the recharging device 200 can transmit an electromagnetic wave carrying the payment data associated with the corresponding amount of money via a short-range communication antenna. Then, the user terminal 100 can approach the recharging device 200 to establish the communication link between the user terminal 100 and the recharging device 200. Then, the balance data of the payer account can be transmitted to the recharging device 200 via the communication link (S400).

The recharging device 200 can transmit the payment data associated with the corresponding amount of money to the user terminal 100 (S402), and the user terminal 100 can receive the payment data and add the payment amount included in the payment data to the payer account (S404). Then, the user terminal 100 can transmit the changed balance data of the payer account to the recharging device 200 via the communication link (S406).

The recharging device 200 can compare the balance data received in S400 with the balance data received in S406 based on the payment data to verify the validity of the balance data (S408).

The recharging device 200 can provide the recharging data and the balance data of the payer account to the financial server 300 (S410). Here, it can be configured in such a way that the financial server 300 verifies the validity of the recharging procedure and the validity of the balance data of the payer account. If it is verified that the recharging procedure is completed normally, the financial server 300 can update the payer account in a database managed by the financial server 300.

Hereinafter, the method of transmitting a certain amount of money from the user terminal to the transaction terminal will be described with reference to the drawings.

FIGS. 5a and 5b are flow diagrams illustrating how a certain amount of money is transmitted from the user terminal to the transaction terminal according to one exemplary embodiment. The type of financial transaction can be any one of an inter-bank transfer, an electronic money transfer, an electronic gift certificate transfer, an electronic coupon transfer and a mileage transfer.

As shown in FIG. 5a, the amount of money to be transmitted is inputted into the user terminal 100 through the input device 160 (S502). For this, the financial transaction application on the user terminal 100 can provide a UI for inputting the amount of money to be transmitted. The financial transaction application can compare the amount of money to be transmitted with the balance data of the payer account, and if the amount of money to be transmitted is larger than the balance, an alert message can be provided to the user.

After inputting the amount of money to be transmitted, the user terminal 100 can approach the transaction terminal 400 to establish the communication link between the two terminals (S504). Here, the user terminal 100 and the transaction terminal 400 may need to be within the communicable distance d.

Then, the user terminal 100 can determine the current position of the user terminal 100 by using the position data of the user terminal 100 that is obtained by the sensors 170. In addition, the user terminal 100 can receive the position data of the transaction terminal 400 via the communication terminal 400 to determine the current position of the transaction terminal. By this, the user terminal 100 can determine the positional relationship between the user terminal 100 and the transaction terminal 400.

For example, if the communication link is established between the user terminal 100 and the transaction terminal 400 by using NFC, and if there is no terminal above the user terminal 100 (S506) but there is a terminal above the transaction terminal 400 (S508), the conditions for transmitting the transaction amount of money from the user terminal 100 to the transaction terminal 400 are satisfied. If any of the above conditions are not satisfied, the financial transaction cannot be performed, in which case the user terminal 100 can output an error message and terminate the financial transaction procedure (S510).

Afterwards, the user terminal 100 can transmit the payment data to the transaction terminal 400 (S512). Here, the user terminal 100 can provide an UI for requesting a confirmation of the financial transaction to the user on the display 155 located on the front face of the user terminal 100, and if the user confirms execution of the financial transaction by inputting the touch input, the payment data can be transmitted to the transaction terminal 400. It is also possible to configure in such a way that the user terminal 100 transmits the payment data without the touch input from the user.

Then, the user terminal 100 can deduct the transaction amount of money from the payer account (S514). Also, once the payment data is received, the transaction terminal 400 can increase the balance of the payee account as much as the transaction amount of money (S516).

Then, the user terminal 100 can transmit the payment data and the deducted balance data of the payer account to the financial server 300. Also, the transaction terminal 400 can transmit the payment data and the increased balance data of the payee account to the financial server 300 (S520).

Then, the financial server 300 can compare the received balance data of the payer account and the payee account against each of the balance data of the payer account and the payee account in the database managed by the financial server 300 (S522). Here, if both the payer account and the payee account are changed accurately (S524), the balance data of the payer account and the payee account in the database are updated (S526), and a transaction approval command is issued to both of the user terminal 100 and the transaction terminal 400 (S528). If either the payer account or the payee account is not accurate or not valid, a transaction cancellation command is issued to both the user terminal 100 and the transaction terminal 400 (S530).

Then, the issued transaction approval/cancellation command is transmitted to the user terminal 100 and the transaction terminal 400 (S532, S534), and the user terminal 100 and the transaction terminal 400 will perform an operation associated with the received transaction approval/cancellation command (S536, S538). If the transaction approval command is received, the changes in the payer account and the payee account are committed, and if the transaction cancellation command is received, the changes are rolled back. Through these operations, it becomes possible for the user terminal 100 to transmit the transaction amount of money to the transaction terminal 400.

In addition, it is possible to provide a UI on the display 155 for requesting a final confirmation to the user at a operation just before finally completing the financial transaction among the user terminal 100, the transaction terminal 400 and the financial server 300.

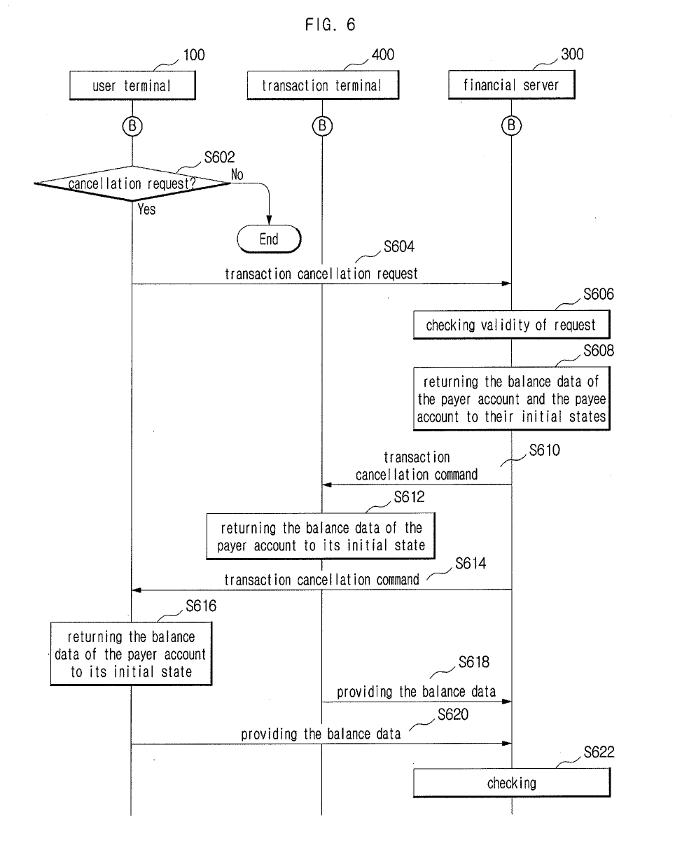

In such a case, the user can confirm or cancel the final operation of financial transaction from a menu shown on the display 155. When a final confirmation is made by the user, all changes that occurred in the user terminal 100, the transaction terminal 400 and the financial server 300 will be finalized. When a cancellation is made by the user, all changes will be returned to their initial states through the procedure shown in FIG. 6.

In another exemplary embodiment, the transaction terminal 400 requests financial data from the user terminal 100.

In this exemplary embodiment, instead of the amount of money to be transmitted being specified in the user terminal 100 in S502 of FIG. 5a, transfer request data for the amount of money to be received can be transmitted from the transaction terminal 400 to the user terminal 100. The transfer request data can be generated in the transaction terminal 400 and transmitted from the transaction terminal 400 to the user terminal 100 after establishing the communication link in S504. The transmitted transfer request data can be displayed on the display 155 of the user terminal 100.

Then, the user terminal 100 can compare the requested amount of money to the balance data of the payer account to determine whether the requested transfer is available or not. The operations after this can be the same as those after S506 in FIG. 5a. In FIG. 6, In case cancellation is made by the user (S602), the user terminal 100 can transmit a transaction cancellation request to the financial server 300 (S604).

Then, the financial server 300 can check for the validity of the received transaction cancellation request (S606). If the transaction cancellation request is valid, the financial server 300 can return the balance data of the payer account and the payee account to their initial states (S608), and transmit a transaction cancellation command to the transaction terminal 400 and the user terminal 100 (S610, S614).

Upon receiving the transaction cancellation command, the user terminal 100 and the transaction terminal 400 can return the reduced balance data and the increased balance data to their initial states (S612, S616), and the initial balance data can be transmitted to the financial server 300 (S618, S620). Then, the financial server 300 can compare the received balance data to the balance data of the payer account and the payee account stored in the database to determine whether the balance data has been accurately returned to their initial states (S622).

In another exemplary embodiment, during the financial transaction from the user terminal 100 to the transaction terminal 400, it is possible to configure the transaction in such a way that transaction approval with the financial server 300 is performed in the order of the user terminal 100, the transaction terminal 400 and the financial server 300, connecting a single financial transaction organically.

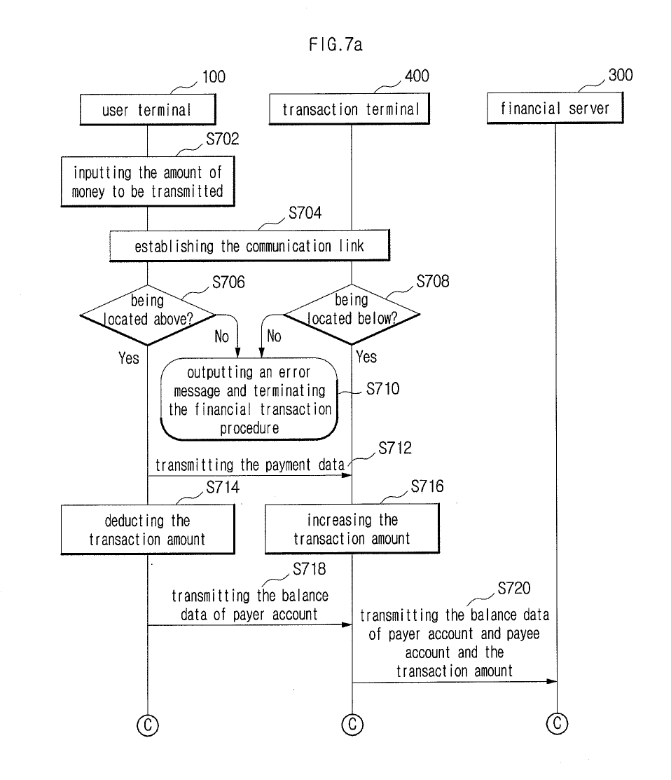

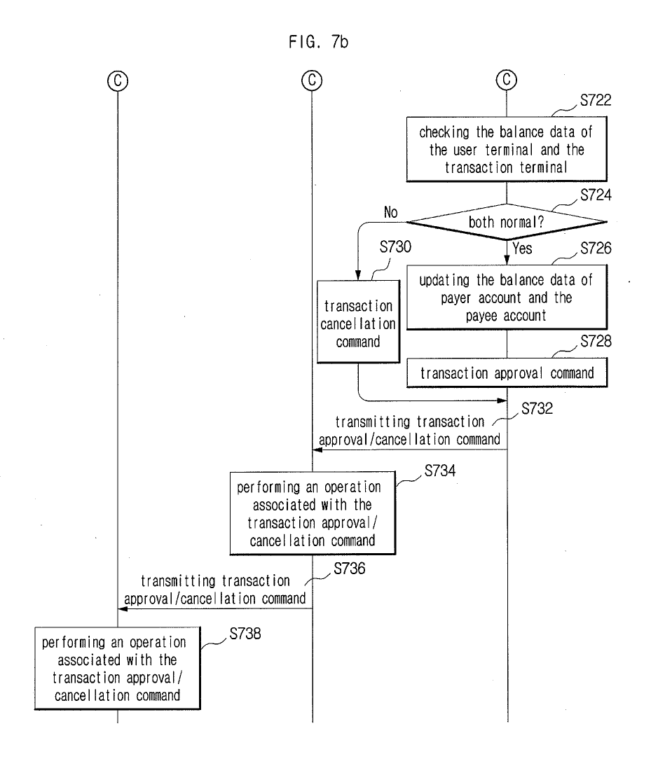

For example, like S718 and S720 in FIG. 7a, a transaction can be configured in such a way that the balance data of the payer account is transmitted from the user terminal 100 to the transaction terminal 400 and the balance data of the payee account and the payment data are transmitted together with the balance data of the payer account to the financial server 300. Also, it is possible to configure in such a way that the transaction approval/cancellation command is transmitted from the financial server 300 is transmitted to the user terminal 100 and the transaction terminal 400 sequentially (S732-S738). Accordingly, it is possible that each operation of the financial transaction is performed consecutively.

Hereinafter, a method of performing the financial transaction between two terminals without the financial server in accordance with another exemplary embodiment will be described. The present exemplary embodiment can be applied to a financial transaction that does not involve the financial server 300. This type of financial transaction can involve at least one of an electronic gift certificate, an electronic coupon and electronic money. Here, the electronic money will be described as an example.

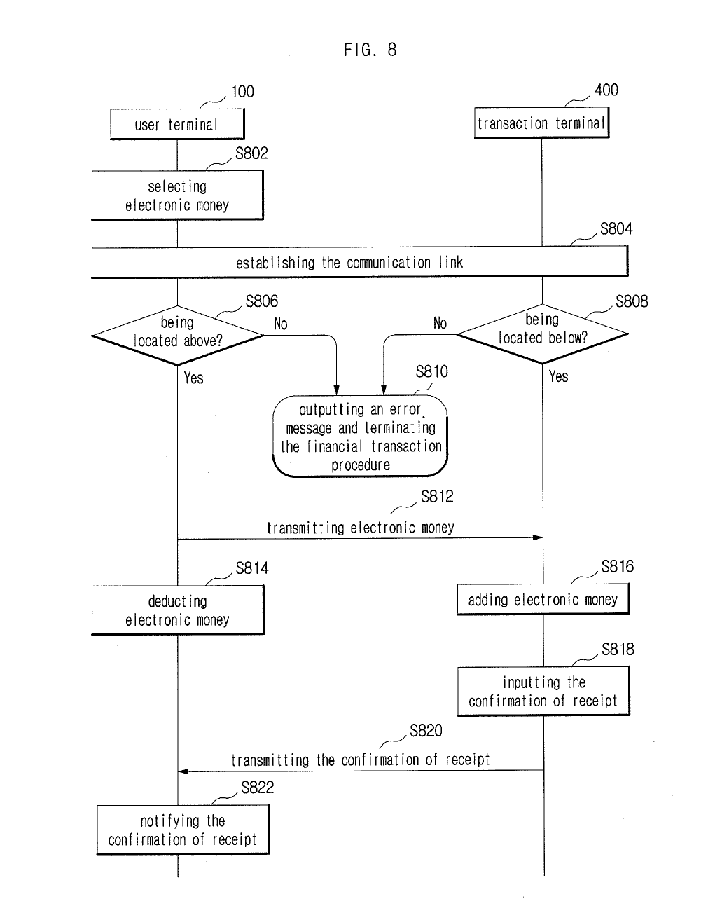

In FIG. 8, the type and quantity of electronic money to be transferred from the user terminal 100 to the transaction terminal 400 is determined (S802). Then, a communication link is established by approaching two terminals (S804).

Then, the positional relationship between the two terminals is assessed. Firstly, it is checked whether the user terminal 100 is placed above the transaction terminal 400 (S806) and whether the transaction terminal 400 is placed beneath the user terminal 100 (S808). If any of the above two conditions is not satisfied while the communication link is established, corresponding financial transaction is not performed, and an error message or an instruction message can be displayed on one or both of the terminals (S810).

If all of the above conditions are met, the electronic money is transferred from the user terminal 100 to the transaction terminal 400 (S812). Then, the amount of transferred money is deducted from the payer account in the user terminal 100, or the corresponding electronic gift certificate or electronic coupon stored in the user terminal 100 is deleted (S814). In the transaction terminal 400, the received electronic money is added, or the received electronic gift certificate or electronic coupon is stored (S816).

Afterwards, confirmation for the transaction can be requested to the user. For example, a recipient can be notified through the display of the transaction terminal 400 that the pertinent financial transaction is completed, and confirmation of receipt can be inputted by the recipient (S818).

The confirmation of receipt can be transmitted to the user terminal 100 (S820), and in response, the user terminal 100 can notify the user of the user terminal 100 that the financial transaction is completed (S822).

Through the aforementioned financial transaction system and method, it is possible to easily perform a financial transaction by placing the user terminal 100 and the transaction terminal 400 in a predetermined position.

The above description has been provided for illustrative purposes only, and it shall be appreciated that it is possible for any ordinarily skilled person in the art to which the present invention pertains to easily modify the present invention without departing from the technical ideas and essential features of the present invention. Therefore, it shall be appreciated that the exemplary embodiments described above are illustrative, not restrictive. For instance, any elements described to be combined can be also embodied by being separated, and likewise, any elements described to be separated can be also embodied by being combined.

Exemplary embodiments shall be defined not by the above description but rather by the claims appended below, and it shall be understood that all possible permutations or modifications that can be contrived from the meanings, scopes and equivalents of the claims are included in the scope of exemplary embodiments.

What is claimed is:

1. A user terminal for performing a financial transaction based on a relative position with a transaction terminal, the user terminal comprising:
a sensor which obtains first position data of the user terminal;
a communication module configured to establish a communication link with the transaction terminal and to communicate with the transaction terminal via the communication link;
a controller which generates payment data for a transaction amount based on the first position data of the user terminal and second position data of the transaction terminal received via the communication link; and
a communication tag configured to store the payment data,
wherein the payment data is transmitted to the transaction terminal via the communication link.

2. The user terminal of claim 1, wherein the communication module comprises a short-range communication module and the communication tag comprises a short-range communication tag.

3. The user terminal of claim 1, wherein the controller determines a positional relationship between the user terminal and the transaction terminal based on the first position data of the user terminal and the second position data of the transaction terminal to generate the payment data if the user terminal is placed above the transaction terminal.

4. The user terminal of claim 1, wherein the sensor comprises at least one from among:
a gyro sensor which determines whether a front face of the user terminal is facing away from the ground; and
a luminance sensor which determines whether the user terminal is placed above the transaction terminal.

5. The user terminal of claim 1, further comprising a mobile communication module configured to communicate with a financial server, the financial server configured to approve the financial transaction.

6. The user terminal of claim 1, further comprising an input device configured to recognize touch input for transmitting the payment data to the transaction terminal.
